(19) United States
(12) Patent Application Publication
(10) Pub. No.: US 2026/0153901 A1
(43) Pub. Date: Jun. 4, 2026

(54) WINDOW FOR DISPLAY DEVICE, METHOD OF MANUFACTURING THE WINDOW, AND DISPLAY DEVICE AND ELECTRONIC DEVICE INCLUDING THE WINDOW

(71) Applicant: Samsung Display Co., LTD., Yongin-si (KR)

(72) Inventors: MIJIN KIM, Yongin-si (KR); EUNJU PARK, Yongin-si (KR); SEUNGWON YOON, Yongin-si (KR); JEONG BONG LEE, Yongin-si (KR); YUSIK JEON, Yongin-si (KR); JONG-WON CHOO, Yongin-si (KR)

(21) Appl. No.: 19/281,038

(22) Filed: Jul. 25, 2025

(30) Foreign Application Priority Data
Dec. 3, 2024 (KR) 10-2024-0177596

(51) Int. Cl. G06F 1/16

(52) U.S. Cl. CPC G06F 1/1656; G06F 1/1616; G06F 1/163

(57) ABSTRACT

Provided is a window, a display device, and an electronic device. The window includes a glass substrate. The glass substrate includes a first part, a second part having a crystallization rate greater than a crystallization rate of the first part and positioned at a first side of the first part, and a third part having a crystallization rate greater than the crystallization rate of the first part and positioned at a second side of the first part. A thickness of the first part is smaller than each of a thickness of the first part and a thickness of the third part.

This application claims priority to Korean Patent Application No. 10-2024-0177596, filed on Dec. 3, 2024, and all the benefits accruing therefrom under 35 U.S.C. § 119, the content of which in its entirety is herein incorporated by reference.

### BACKGROUND

### Field

The present disclosure herein relates to a window, a method of manufacturing the window, and a display device and an electronic device including the window, and more particularly, to a window including two types of glass substrates, a display device including the window, and an electronic device including the window.

### Description of the Related Art

An electronic device may display an image to provide information to a user. Currently, various types of electronic devices are being developed. In particular, foldable electronic devices are being developed.

An electronic device may include a display device and a window. The window may include a glass substrate. A window is desired which improves the impact resistance and strength of the window providing the outer surface and reduces stress occurring during folding.

### SUMMARY

The present disclosure provides a window for a display device having improved impact resistance and reduced folding stress.

The present disclosure provides a method of manufacturing the window.

The present disclosure provides a display device including the window.

The present disclosure provides an electronic device including the window.

An embodiment of the inventive concept provides a window including a glass substrate. The glass substrate includes a first part, a second part having a crystallization rate greater than a crystallization rate of the first part and positioned at a first side of the first part, and a third part having a crystallization rate greater than the crystallization rate of the first part and positioned at a second side of the first part. A thickness of the first part is smaller than each of a thickness of the second part and a thickness of the third part.

In an embodiment, the crystallization rate of the second part may range from about 30% to about 80%.

In an embodiment, the second part may include an upper surface and an inclined surface extending from the upper surface of the second part. The third part may include an upper surface and an inclined surface extending from the upper surface of the third part. The inclined surface of the second part and the inclined surface of the third part may be opposite to each other with the first part between the inclined surface of the second part and the inclined surface of the third part.

In an embodiment, the first part may further include a lower surface opposite to the upper surface of the first part, and the second part may further include a lower surface opposite to the upper surface of the second part, and the third part may further include a lower surface opposite to the upper surface of the third part. The lower surface of the first part, the lower surface of the second part, and the lower surface of the third part may define a flat surface.

In an embodiment, an elastic modulus of the first part may be smaller than an elastic modulus of the second part.

In an embodiment, the thickness of the first part may range from about 10 μm to about 50 μm, and the thickness of the second part may range from about 50 μm to about 100 μm.

An embodiment of the inventive concept provides a method of manufacturing a window for a display device including providing a first glass substrate including amorphous glass, a second glass substrate including crystalline glass, and a third glass substrate including the crystalline glass, bonding a first side surface of the first glass substrate and a side surface of the second glass substrate, and bonding a side surface of the third glass substrate and a second side surface, of the first glass substrate, opposite to the first side of the first glass. A thickness of the first glass substrate is smaller than each of a thickness of the second glass substrate and a thickness of the third glass substrate.

In an embodiment, the bonding of the first side surface of the first glass substrate and the side surface of the second glass substrate may include providing a plasma stream to the first side surface of the first glass substrate and the side surface of the second glass substrate.

An embodiment of the inventive concept may provide a display device including a display panel including a folding region, a first non-folding region, and a second non-folding region, wherein the first non-folding region and the second non-folding region are opposite to each other with the folding region therebetween, and a window including a glass substrate and coupled to the display panel. The glass substrate may include, a first part overlapping the folding region, a second part overlapping the first non-folding region, having a crystallization rate greater than a crystallization rate of the first part, and positioned at a first side of the first part, and a third part overlapping the second non-folding region, having a crystallization rate greater than the crystallization rate of the first part, and positioned at a second side of the first part. The second part and the third part are opposite to each other with the first part between the second part and the third part, and a thickness of the first part is smaller than each of a thickness of the second part and a thickness of the third part.

In an embodiment, the second part may include an upper surface and an inclined surface extending from the upper surface of the second part. The third part may include an upper surface and an inclined surface extending from the upper surface of the third part. The inclined surface of the second part and the inclined surface of the third part may be opposite to each other with the first part between the inclined surface of the second part and the inclined surface of the third part.

In an embodiment, an elastic modulus of the first part may be smaller than an elastic modulus of the second part.

In an embodiment, the thickness of the first part ranges from about 10 μm to about 50 μm, and the thickness of the second part may range from about 50 μm to about 100 μm.

An embodiment of the inventive concept provides an electronic device including a display device including a folding region, a first non-folding region, and a second non-folding region, wherein the first non-folding region and the second non-folding region are opposite to each other with the folding region between the first non-folding region and the second non-folding region, and a housing accommodating the display device. The display device may include a display panel and a window coupled to the display panel. The window may include a glass substrate, and the glass substrate includes a first part overlapping the folding region, a second part overlapping the first non-folding region, having a crystallization rate greater than a crystallization rate of the first part, and positioned at a first side of the first part, and a third part overlapping the second non-folding region, having a crystallization rate greater than the crystallization rate of the first part, and positioned at a second side of the first part. The second part and the third part are opposite to each other with the first part between the second part and the third part, and a thickness of the first part is smaller than each of a thickness of the second part and a thickness of the third part.

In an embodiment, the electronic device may be any one among a mobile phone, a smart watch, or an information providing device for a vehicle.

In an embodiment, the second part includes an upper surface and an inclined surface extending from the upper surface of the second part, and the third part may include an upper surface and an inclined surface extending from the upper surface of the third part. The inclined surface of the second part and the inclined surface of the third part may be opposite to each other with the first part between the inclined surface of the second part and the inclined surface of the third part.

In an embodiment, an elastic modulus of the first part may be smaller than an elastic modulus of the second part.

In an embodiment, a thickness of the first part ranges from about 10 μm to about 50 μm, and a thickness of the second part may range from about 50 μm to about 100 μm.

In an embodiment, the first part may include amorphous glass.

In an embodiment, the crystallization rate of the second part may range from about 30% to about 80%.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A is a block diagram of an electronic device according to an embodiment of the inventive concept;

FIGS. 1B to 1D are perspective views of an electronic device according to an embodiment of the inventive concept;

FIGS. 2A to 2C are perspective views of an electronic device according to an embodiment of the inventive concept;

FIG. 3 is an exploded perspective view of a display device according to an embodiment of the inventive concept;

FIGS. 4A and 4B are cross-sectional views of a window according to an embodiment of the inventive concept;

FIG. 4C is an enlarged cross-sectional view of a portion of FIG. 4A;

FIG. 4D is an enlarged cross-sectional view of a first part of FIG. 4C;

FIGS. 5A and 5B are cross-sectional views of a window according to an embodiment of the inventive concept;

FIG. 6 is a flowchart illustrating a method of manufacturing a window according to an embodiment of the inventive concept;

FIG. 7 is a diagram illustrating plasma bonding equipment according to an embodiment of the inventive concept; and

FIG. 8 illustrates a bonding process of a chemically strengthened first glass substrate and a processed second glass substrate.

### DETAILED DESCRIPTION

In this specification, when a component (or region, layer, portion, or the like) is referred to as being “on”, “connected to” or “coupled to” another component, it means that it may be directly disposed on/connected to/coupled to the other component, or a third component may be disposed therebetween.

An identical drawing reference numeral refers to an identical component throughout. In the drawings, the thickness, ratio, and size of the component are exaggerated for the purpose of effectively describing the technical contents. The term “and/or” includes all combinations of one or more that the associated components may define.

The terms “first”, “second”, and the like may be used to describe various components, but such components should not be limited by such terms. These terms are used solely to distinguish one component, part, region, layer or portion from another component, part, region, layer or portion. For example, without departing from the scope of the present invention, a first component, a first part, a first region, a first layer or a first portion could be termed a second component, a second part, a second region, a second layer or a second portion, and similarly, a second component, a second part, a second region, a second layer or a second portion could also be termed a first component, a first part, a first region, a first layer or a first portion. The singular expressions include the plural expressions unless the context clearly dictates otherwise.

The terms “below”, “under”, “on the lower side”, “above”, “over”, “on the upper side”, or the like may be used to describe the relationships between the components illustrated in the drawings. These terms are relative concepts and are described on the basis of the directions indicated in the drawings.

It should be understood that the terms “include” or “have” are intended to specify the presence of a feature, number, step, operation, component, part, or combination thereof described in the specification, but do not exclude in advance the possibility of the presence or addition of one or more other features, numbers, steps, operations, components, parts, or combinations thereof.

The terms “about” or “approximately” as used herein are inclusive of the stated value and include a suitable range of deviation for the particular value as determined by one of ordinary skill in the art, considering the measurement in question and the error associated with measurement of the particular quantity. The terms “about” or “approximately” can mean within one or more standard deviations, or within ±30%, 20%, 10%, 5% of the stated value, for example.

The term “substantially,” as used herein, means approximately or actually. The term “substantially uniform” means approximately or actually uniform. The term “substantially equal” means approximately or actually equal. The term “substantially the same” means approximately or actually the same. The term “substantially perpendicular” means approximately or actually perpendicular. The term “substantially parallel” means approximately or actually parallel.

Unless otherwise defined, all terms (including technical and scientific terms) used herein have the same meaning as commonly understood by one of ordinary skill in the art to which this invention belongs. Terms such as those defined in commonly used dictionaries should be interpreted to have a meaning consistent with the meaning they have in the context of the relevant technology, and should not be interpreted in an overly idealistic or overly formal sense unless explicitly defined herein.

Hereinafter, embodiments of the inventive concept are described with reference to the drawings.

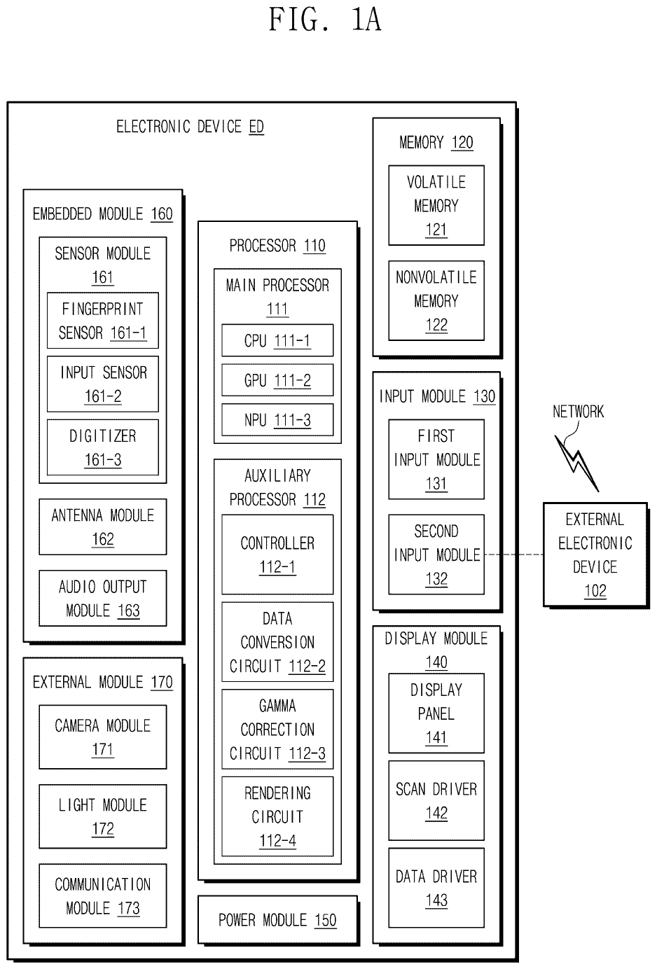

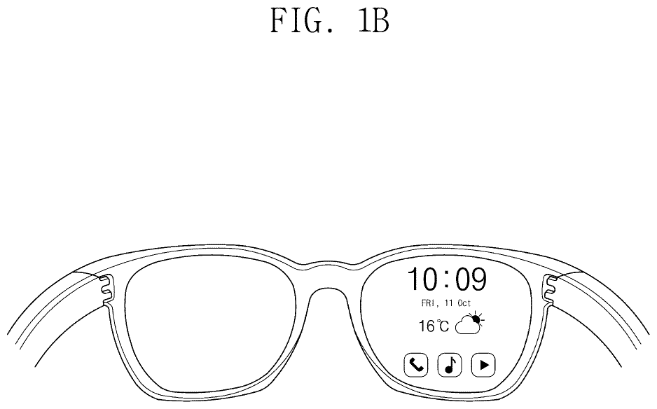

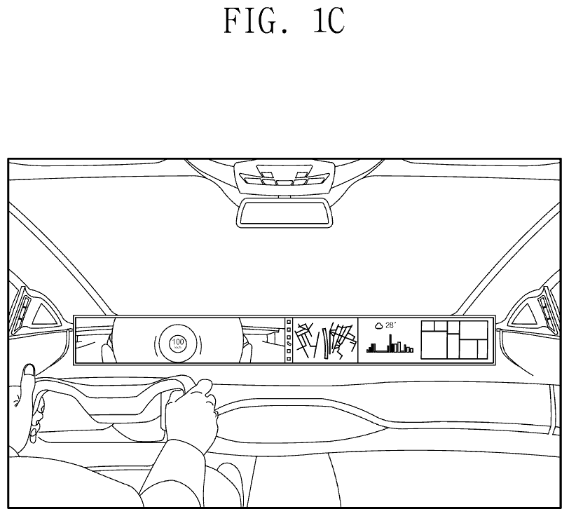

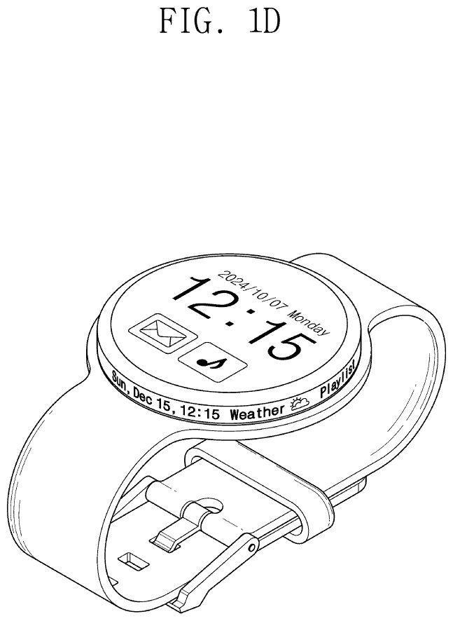

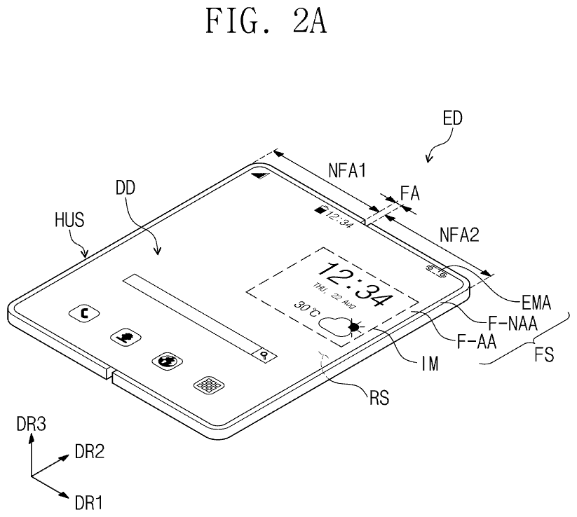

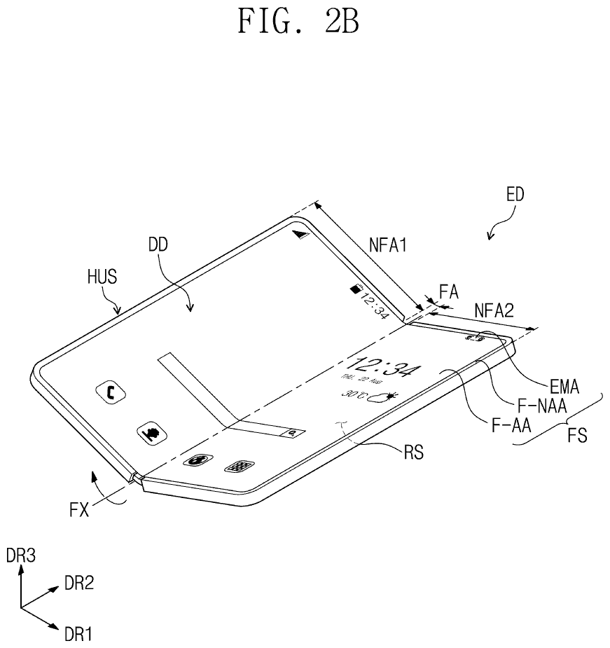

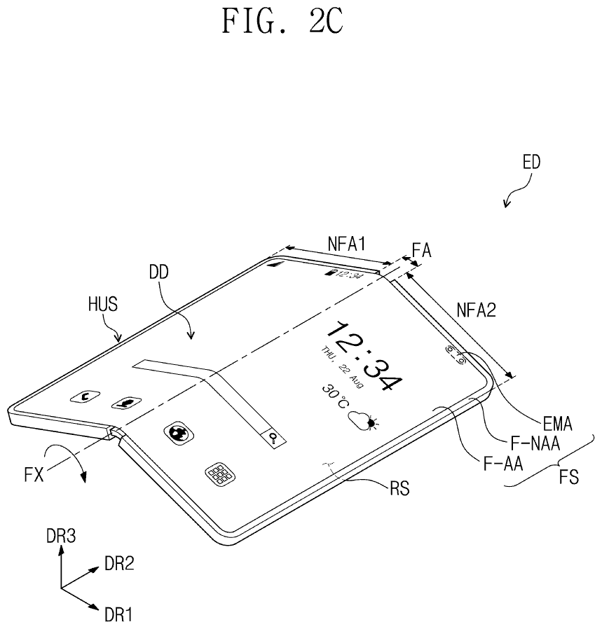

FIG. 1A is a block diagram of an electronic device ED according to an embodiment of the inventive concept. FIGS. 1B to 1D are perspective views of an electronic device according to an embodiment of the inventive concept. FIGS. 2A to 2C are perspective views of an electronic device ED according to an embodiment of the inventive concept.

The electronic device ED according to an embodiment of the inventive concept includes a display device DD. The electronic device ED according to an embodiment of the inventive concept may be a foldable phone as illustrated in FIGS. 2A to 2C but is not limited thereto.

As illustrated in FIG. 1A, the electronic device ED outputs various information through a display module 140 in an operating system. In an example in which a processor 110 executes an application stored in a memory 120, the display module 140 provides application information to a user through a display panel 141.

The processor 110 acquires an external input through an input module 130 or a sensor module 161 and executes an application corresponding to the external input. In an example in which the user selects a camera icon displayed on the display panel 141, the processor 110 acquires the input of the user through an input sensor 161-2 and activates a camera module 171. The processor 110 transfers image data corresponding to a captured image acquired through the camera module 171 to the display module 140. The display module 140 may display an image corresponding to the captured image through the display panel 141.

As another example, when personal information authentication is executed in the display module 140, a fingerprint sensor 161-1 acquires input fingerprint information as input data. The processor 110 compares the input data acquired through the fingerprint sensor 161-1 with authentication data stored in the memory 120, and executes an application corresponding to the result of comparison. The display module 140 may display, through the display panel 141, information executed according to a logic of the application.

As another example, when a music streaming icon displayed on the display module 140 is selected, the processor 110 acquires an input of a user through the input sensor 161-2 and activates a music streaming application stored in the memory 120. In an example in which a music execution command is input in the music streaming application, the processor 110 activates an audio output module 163 to provide the user with audio information corresponding to the music execution command.

With reference to the above, the operation of the electronic device ED is briefly described. Hereinafter, a configuration of the electronic device ED will be described in detail. Some of components of the electronic device ED to be described later may be integrated and provided as one component, and one component may be provided as two or more separate components.

Referring to FIG. 1A, the electronic device ED may communicate with an external electronic device 102 through a network (for example, a short-range wireless communication network or a long-distance wireless communication network). According to an embodiment, the electronic device ED may include the processor 110, the memory 120, the input module 130, the display module 140, a power module 150, an embedded module 160, and an external module 170. According to an embodiment, in the electronic device ED, at least one of the described components may be omitted, or one or more of the other components may be added. According to an embodiment, some of the components (for example, the sensor module 161, an antenna module 162, or the audio output module 163) may be integrated into another component (for example, the display module 140).

The processor 110 may execute software to control at least one other component (for example, a hardware or software component) of the electronic device ED connected to the processor 110, and may perform various data processing or arithmetic operations. According to an embodiment, as at least portion of data processing or arithmetic operations, the processor 110 may store commands or data received from other components (for example, the input module 130, the sensor module 161, or a communication module 173) in a volatile memory 121, and may process commands or data stored in the volatile memory 121, and the result data may be stored in a non-volatile memory 122.

The processor 110 may include a main processor 111 and an auxiliary processor 112. The main processor 111 may include at least one of a central processing unit (CPU) 111-1 or an application processor (AP). The main processor 111 may further include one or more among a graphic processing unit (GPU) 111-2, a communication processor (CP), and an image signal processor (ISP). The main processor 111 may further include a neural network processing unit (NPU) 111-3. The neural network processing unit is a processor specialized in processing an artificial intelligence model, and the artificial intelligence model may be created through machine learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRNN), deep Q-networks, or one of combinations of two or more of the described networks, but is not limited to examples described herein. In addition to the hardware structure, the artificial intelligence model may additionally or alternatively include a software structure. At least two among the described processing units and processors may be implemented as one integrated component (for example, a single chip), or each may be implemented as an independent component (for example, a plurality of chips).

The auxiliary processor 112 may include a controller 112-1. The controller 112-1 may include an interface conversion circuit and a timing control circuit. The controller 112-1 receives an image signal from the main processor 111, converts a data format of the image signal to comply with an interface specification for the display module 140, and outputs the image data. The controller 112-1 may output various types of control signals supportive of driving the display module 140.

The auxiliary processor 112 may further include a data conversion circuit 112-2, a gamma correction circuit 112-3, a rendering circuit 112-4, and the like. The data conversion circuit 112-2 may receive image data from the controller 112-1 and may compensate for the image data such that an image is displayed to have a desired luminance according to characteristics of the electronic device ED or user settings, or may convert the image data to reduce power consumption or to compensate for afterimages. The gamma correction circuit 112-3 may convert the image data or a gamma reference voltage such that an image displayed on the electronic device ED has desired gamma characteristics. The rendering circuit 112-4 may receive image data from the controller 112-1 and may render the image data in consideration of a pixel arrangement of the display panel 141 applied to the electronic device ED. At least one of the data conversion circuit 112-2, the gamma correction circuit 112-3, or the rendering circuit 112-4 may be integrated into another component (e.g., the main processor 111 or the controller 112-1). At least one of the data conversion circuit 112-2, the gamma correction circuit 112-3, or the rendering circuit 112-4 may be integrated into a data driver 143 to be described later.

The memory 120 may store various data used by at least one component (for example, the processor 110 or the sensor module 161) of the electronic device ED, and input or output data for commands related thereto. The memory 120 may include at least one of the volatile memory 121 or the non-volatile memory 122.

The input module 130 may receive a command or data to be used for a component (for example, the processor 110, the sensor module 161, or the audio output module 163) of the electronic device ED from the outside of the electronic device ED (for example, the user or the external electronic device 102).

The input module 130 may include a first input module 131 to which a command or data are input from the user and a second input module 132 to which a command or data are input from the external electronic device 102. The first input module 131 may include a microphone, a mouse, a keyboard, a key (for example, a button) or a pen (for example, a passive pen or an active pen). The second input module 132 may support a specified protocol capable of connecting to the external electronic device 102 in a wire or wireless manner. According to an embodiment, the second input module 132 may include a high definition multimedia interface (HDMI), a universal serial bus (USB) interface, a secure digital (SD) card interface, or an audio interface. The second input module 132 may include a connector capable of physically connecting with the external electronic device 102, for example, an HDMI connector, a USB connector, an SD card connector, or an audio connector (for example, a headphone connector).

The display module 140 visually provides information to the user. The display module 140 may include the display panel 141, a scan driver 142, and the data driver 143. The display module 140 may further include a window, a chassis, and a bracket for protecting the display panel 141.

The display panel 141 may include a liquid crystal display panel, an organic light-emitting display panel, or an inorganic light-emitting display panel, and the type of the display panel 141 is not particularly limited. The display panel 141 may be a rigid panel or a flexible panel which is rollable or foldable. The display module 140 may further include a supporter, a bracket, a heat dissipating member, or the like which supports the display panel 141.

The scan driver 142 may be mounted, as a driving chip, on the display panel 141. In some aspects, the scan driver 142 may be integrated in the display panel 141. For example, the scan driver 142 may include an amorphous silicon TFT gate driver circuit (ASG), a low temperature polycrystalline silicon (LTPS) TFT gate driver circuit, or an oxide semiconductor TFT gate driver circuit (OSG) embedded in the display panel 141. The scan driver 142 receives a control signal from the controller 112-1 and outputs scan signals to the display panel 141 in response to the control signal.

The display panel 141 may further include an emission driver. The emission driver outputs an emission control signal to the display panel 141 in response to the control signal received from the controller 112-1. The emission driver may be formed separately from the scan driver 142 or may be integrated in the scan driver 142.

The data driver 143 receives a control signal from the controller 112-1, converts image data into an analog voltage (for example, data voltage) in response to the control signal, and then outputs the data voltage to the display panel 141.

The data driver 143 may be integrated in another component (for example, the controller 112-1). The functions of the interface conversion circuit and the timing control circuit of the controller 112-1 described herein may also be integrated in the data driver 143.

The display module 140 may further include an emission driver, a voltage generation circuit, and the like. The voltage generation circuit may output various voltages supportive of driving the display panel 141.

The power module 150 supplies power to a component of the electronic device ED. The power module 150 may include a battery which charges a power voltage. The battery may include a non-rechargeable primary battery, a rechargeable secondary battery, or a fuel cell. The power module 150 may include a power management integrated circuit (PMIC). The PMIC supplies power optimized for each of the modules described herein and modules to be described later. The power module 150 may include a wireless power transmission/reception member electrically connected to the battery. The wireless power transmission/reception member may include a plurality of coil-shaped antenna radiators.

The electronic device ED may further include the embedded module 160 and the external module 170. The embedded module 160 may include the sensor module 161, the antenna module 162, and the audio output module 163. The external module 170 may include the camera module 171, a light module 172, and the communication module 173.

The sensor module 161 may detect an input applied by a body of the user or an input applied by a pen among the first input modules 131, and may generate an electrical signal or data value corresponding to the input. The sensor module 161 may include at least one of the fingerprint sensor 161-1, the input sensor 161-2, or a digitizer 161-3.

The fingerprint sensor 161-1 may generate a data value corresponding to a fingerprint of the user. The fingerprint sensor 161-1 may include either an optical-type or a capacitive-type fingerprint sensor.

The input sensor 161-2 may generate a data value corresponding to coordinate information about an input from a body of the user or an input from the pen. The input sensor 161-2 generates, as a data value, an electrostatic capacitance variations caused by the input. The input sensor 161-2 may detect an input from a passive pen or may transmit or receive data to or from an active pen.

The input sensor 161-2 may also measure biometric signals such as, for example, blood pressure, moisture, and body fat. In an example in which the user brings a portion of a body of the user to contact the sensor layer or the sensing panel and remains stationary for a certain time, the input sensor 161-2 may detect a biometric signal on the basis of a change in the electric field caused by the portion of the body of the user and may output information desired by the user to the display module 140.

The digitizer 161-3 may generate a data value corresponding to coordinate information about an input from a pen. The digitizer 161-3 generates, as a data value, electromagnetic variations caused by the input. The digitizer 161-3 may detect an input from a passive pen or may transmit or receive data to or from an active pen.

At least one of the fingerprint sensor 161-1, the input sensor 161-2, or the digitizer 161-3 may be implemented as a sensor layer formed on the display panel 141 through a continuous process. The fingerprint sensor 161-1, the input sensor 161-2, and the digitizer 161-3 may be disposed in an upper portion of the display panel 141, and any one among the fingerprint sensor 161-1, the input sensor 161-2, and the digitizer 161-3, for example, the digitizer 161-3 may be disposed in a lower portion of the display panel 141.

At least two among the fingerprint sensor 161-1, the input sensor 161-2, and the digitizer 161-3 may be integrated into a single sensing panel through a same process. In an example in which at least two among the fingerprint sensor 161-1, the input sensor 161-2, and the digitizer 161-3 is integrated into a single sensing panel, the sensing panel may be disposed between the display panel 141 and a window disposed above the display panel 141. According to an embodiment, the sensing panel may be disposed on the window, and the position of the sensing panel is not particularly limited.

At least one of the fingerprint sensor 161-1, the input sensor 161-2, or the digitizer 161-3 may be embedded in the display panel 141. That is, at least one of the fingerprint sensor 161-1, the input sensor 161-2, or the digitizer 161-3 may be simultaneously formed through the process of forming an element (for example, a light-emitting element, a transistor, and the like) included in the display panel 141.

In some aspects, the sensor module 161 may generate an electrical signal or data value corresponding to an internal state or an external state of the electronic device ED. The sensor module 161 may further include, for example, a gesture sensor, a gyroscope sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 162 may include one or more antennas for transmitting or receiving a signal or power to or from the outside. According to an embodiment, the communication module 173 may transmit or receive a signal to or from an external electronic device through an antenna suitable for a communication scheme. An antenna pattern of the antenna module 162 may also be integrated with one component (for example, the display panel 141) of the display module 140, or the input sensor 161-2, or the like.

The audio output module 163 is a device for outputting an audio signal to the outside of the electronic device ED, and may include, for example, a speaker used for general purposes, such as, for example, playback of multimedia or playback of recording, and a receiver used for phone call reception. According to an embodiment, the receiver may be integrally or separately formed with the speaker. An audio output pattern of the audio output module 163 may be integrated in the display module 140.

The camera module 171 may capture a still image and a moving image. According to an embodiment, the camera module 171 may include one or more lenses, an image sensor, or an image signal processor. The camera module 171 may further include an infrared camera capable of measuring the presence or absence of a user, a position of the user, and a line-of-sight of the user, and the like.

The light module 172 may provide light. The light module 172 may include a light-emitting diode or a xenon lamp. The light module 172 may be operated interlocking with the camera module 171 or may be operated independently from the camera module 171.

The communication module 173 may establish a wire or wireless communication channel between the electronic device ED and the external electronic device 102, and may support execution of communication through the established communication channel. The communication module 173 may include either/both a wireless communication module such as, for example, a cellular communication module, a short-range wireless communication module, or a global navigation satellite system (GNSS) communication module, or/and a wire communication module such as, for example, a local area network (LAN) communication module, or a power line communication module. The communication module 173 may communicate with the external electronic device 102 through a short-range communication network such as, for example, Bluetooth, WiFi direct, or infrared data association (IrDA), or a long-range communication network such as, for example, a cellular network, an Internet, or a computer network (for example, LAN or WAN). The various types of communication modules 173 described herein may be implemented as a single chip or each may be implemented as a separate chip.

The input module 130, the sensor module 161, the camera module 171, and the like may be used to control, interlocking with the processor 110, the operation of the display module 140.

The processor 110 outputs a command or data to the display module 140, the audio output module 163, the camera module 171, or the light module 172 on the basis of the input data received from the input module 130. For example, the processor 110 may generate image data corresponding to input data applied through a mouse or an active pen to output the image data to the display module 140, or may generate command data corresponding to input data to output the command data to the camera module 171 or the light module 172. In an example in which input data is not received from the input module 130 for a certain time, the processor 110 may reduce power consumption in the electronic device ED by switching the operation mode of the electronic device ED to a low-power mode or sleep mode.

The processor 110 outputs a command or data to the display module 140, the audio output module 163, the camera module 171, or the light module 172 on the basis of the sensing data received from the sensor module 161. For example, the processor 110 may compare the authentication data applied from the fingerprint sensor 161-1 with the authentication data stored in the memory 120 and then may execute an application according to the result of the comparison. The processor 110 may execute a command on the basis of sensing data detected by the input sensor 161-2 or the digitizer 161-3 or may output corresponding image data to the display module 140. In an example in which a temperature sensor is included in the sensor module 161, the processor 110 may receive temperature data about the temperature measured from the sensor module 161 and may further perform a luminance correction operation on the image data on the basis of the temperature data.

The processor 110 may receive measurement data about the presence or absence of a user, a position of the user, a line-of-sight of the user, and the like from the camera module 171. The processor 110 may further perform a luminance correction operation or the like on the image data on the basis of the measurement data. For example, the processor 110, which determines the presence or absence of the user through an input from the camera module 171, may output, to the display module 140, image data of which luminance is corrected through the data conversion circuit 112-2 or the gamma correction circuit 112-3.

Some components among the components may be connected to each other by a communication scheme between peripheral devices, such as, for example, a bus, a general purpose input/output (GPIO), a serial peripheral interface (SPI), a mobile industry processor interface (MIPI), and an ultra-path interconnect (UPI) link, and may thus exchange a signal (for example, a command or data) therebetween. The processor 110 may communicate with the display module 140 through an interface which is mutually agreed upon, and for example, may use any one of the communication schemes described herein, and embodiments of the inventive concept are not limited to the communication schemes described herein.

The electronic device ED according to various embodiments disclosed in this document may be various types of devices. For example, the electronic device ED may include at least one among a portable communication device (for example, a smart phone), a tablet device, a portable multimedia device, a wearable device, and a home appliance. The electronic device ED according to an embodiment of this document is not limited to the devices described herein. The AR glass illustrated in FIG. 1B, the various types of vehicular information providing devices illustrated in FIG. 1C, and the smart watch illustrated in FIG. 1D may be implemented as the electronic device ED of the inventive concept.

Referring to FIGS. 2A to 2C, the electronic device ED may include a display device DD and a housing HUS that accommodates the display device DD. The electronic device ED may include a display surface FS provided by the display device DD. The display surface FS may be defined by a first direction DR1 and a second direction DR2 crossing the first direction DR1. The electronic device ED may provide the image IM to a user through the display surface FS. The image IM is provided in a third direction DR3.

The display surface FS of the electronic device ED according to an embodiment may include a display region F-AA and a peripheral region F-NAA. The image IM may be displayed through the display region F-AA. The peripheral region F-NAA is adjacent to the display region F-AA. The peripheral region F-NAA may not display the image IM and may have a predetermined color. The peripheral region F-NAA may surround the display region F-AA, but is not limited thereto, and the peripheral region F-NAA may be disposed adjacent to a single side of the display region F-AA or may be omitted. The electronic device ED according to an embodiment of the inventive concept may include various shapes of active regions, and is not limited to any one embodiment.

The display surface FS may further include a sensing region EMA. Various electronic modules may be disposed in the sensing region EMA. For example, the electronic module may include at least one of a camera module, a light detection sensor, or a heat detection sensor. The sensing region EMA may be surrounded by the display region F-AA. Although one sensing region EMA is illustrated as an example, the number of sensing regions EMA is not limited thereto.

The sensing region EMA may be a portion of the display region F-AA. Therefore, the image IM may be displayed even in the sensing region EMA. In an example in which the electronic modules disposed in the sensing region EMA are deactivated, the sensing region EMA may display the image IM as a portion of the display region F-AA.

The display surface FS may include a folding region FA and non-folding regions NFA1 and NFA2. The electronic device ED may include a plurality of non-folding regions NFA1 and NFA2. The electronic device ED according to an embodiment may include a first non-folding region NFA1 and a second non-folding region NFA2 disposed with the folding region FA between the first non-folding region NFA1 and the second non-folding region NFA2. Although FIGS. 2A to 2C illustrate an embodiment of the electronic device ED including one folding region FA, embodiments of the present disclosure are not limited thereto, and the electronic device ED may include a plurality of folding regions.

Referring to FIGS. 2B and 2C, the electronic device ED may be folded with respect to a folding axis FX extending in one direction. The folding axis FX illustrated in FIGS. 2B and 2C, which is a virtual axis extending in the second direction DR2, is defined to overlap in the folding region FA and may be parallel to the long side direction of the electronic device ED.

Referring to FIG. 2B, the electronic device ED may be folded such that the first non-folding region NFA1 and the second non-folding region NFA2 face each other. That is, the display surface FS may be in-folded so as not to be exposed to the outside. Referring to FIG. 2C, the electronic device ED according to an embodiment of the inventive concept may be out-folded such that the display surface FS is exposed to the outside.

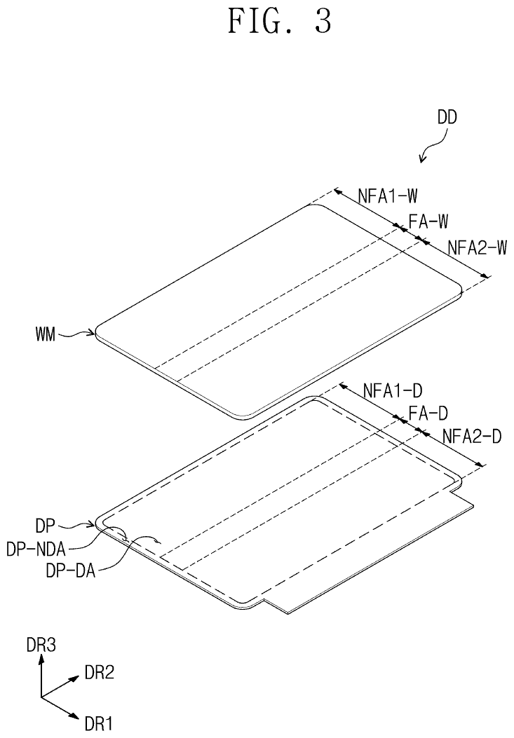

FIG. 3 is an exploded perspective view of a display device DD according to an embodiment of the inventive concept.

The display device DD according to an embodiment of the inventive concept includes a display panel DP and a window WM disposed on the display panel DP.

The display panel DP may be a light-emitting display panel. For example, the display panel DP may be an organic light-emitting display panel, an inorganic light-emitting display panel, a micro LED display panel, a micro OLED display panel, or a nano LED display panel.

The display panel DP may include a display region DP-DA and a non-display region DP-NDA. The display region DP-DA is a region in which pixels are disposed, and generates the image IM described with reference to FIGS. 2A to 2C. The display region DP-DA of the display panel DP may correspond to the display region F-AA described herein with reference to FIGS. 2A to 2C. The non-display region DP-NDA may correspond to the peripheral region F-NAA described with reference to FIGS. 2A to 2C. In this specification, the expression “one region (or portion) corresponds to the other region (or portion)” indicates that the regions overlap each other, and is not limited to the regions having the same shape and the same area.

The display panel DP may include a folding region FA-D and first and second non-folding regions NFA1-D and NFA2-D that respectively correspond to the folding region FA and the first and second non-folding regions NFA1 and NFA2 of the electronic device ED (or display device DD) of FIGS. 2A to 2C. In FIG. 3, a region of the second non-folding region NFA2-D, protruding from the window WM, may be bent and disposed under the second non-folding region NFA2-D.

The window WM provides the display surface FS described herein with reference to FIGS. 2A to 2C. That is, the window WM may provide a front surface of the electronic device ED. The window WM may include a folding region FA-W and first and second non-folding regions NFA1-W and NFA2-W that respectively correspond to the folding region FA and the first and second non-folding regions NFA1 and, NFA2 of the electronic device ED. The folding region FA-W is deformed at a predetermined curvature when the electronic device ED is folded.

The window WM may include a base substrate and a bezel pattern disposed on a surface of the base substrate. A region in which the bezel pattern is disposed may define the peripheral region F-NAA described with reference to FIGS. 2A to 2C. In an embodiment of the inventive concept, the bezel pattern may be omitted.

In FIG. 3, other components of the display device DD are not illustrated except for the display panel DP and the window WM. For example, the display device DD may further include a protective layer disposed above the window WM, an input sensor disposed between the window WM and the display panel DP, a support plate and a cushion layer disposed under the display panel DP.

In FIG. 3, other components of the electronic device ED are not illustrated except for the display device DD, compared to FIGS. 2A to 2C. For example, the housing HUS is not illustrated. Electronic modules, for example, the processor 110, the memory 120, and the power module 150 described with reference to FIG. 1A may be disposed in a space defined by the display device DD and the housing HUS. In some aspects, other components described with reference to FIGS. 2A to 2C may be further disposed in the space.

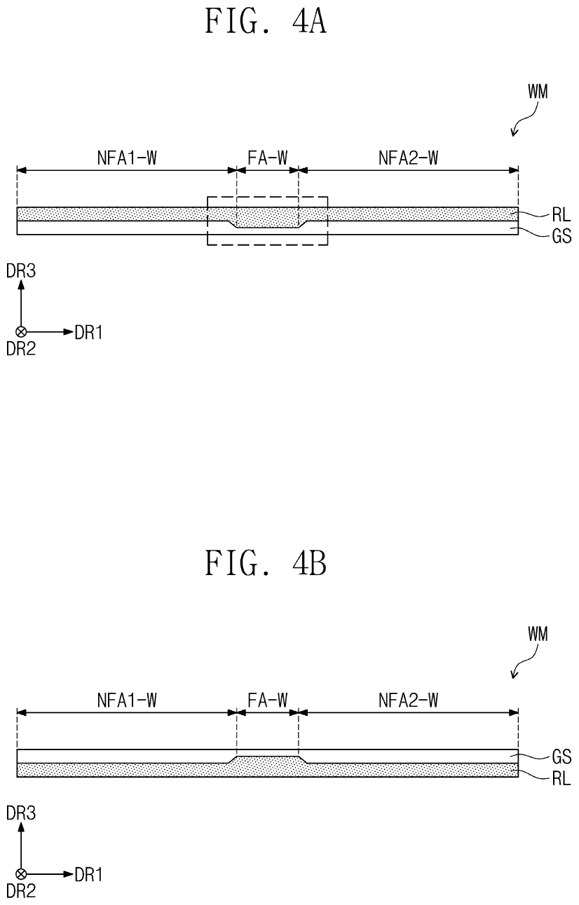

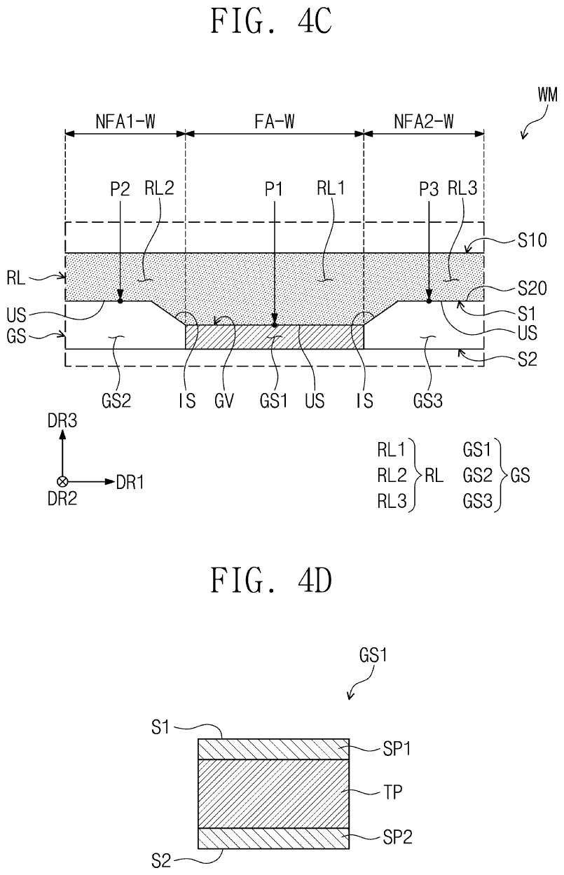

FIGS. 4A and 4B are cross-sectional views of a window WM according to an embodiment of the inventive concept. FIG. 4C is an enlarged cross-sectional view of a portion of FIG. 4A. FIG. 4D is an enlarged cross-sectional view of a first part GS1 of FIG. 4C.

Referring to FIGS. 4A and 4B, the window WM may include a glass substrate GS and a resin layer RL disposed on a surface of the glass substrate GS. The resin layer RL may include an acrylic resin, an epoxy resin, a silicone resin, a urethane resin, a urethane acrylic resin, a hybrid sol gel, and a siloxane-based resin. The window WM having the structure described herein may have improved impact resistance through the resin layer RL while maintaining optical characteristics and design characteristics of the glass substrate GS.

In FIG. 4A, an upper surface of the resin layer RL may provide the display surface FS of FIGS. 2A to 2C. FIG. 4B illustrates, for example, the window WM in which positions of the glass substrate GS and the resin layer RL are reversed, compared to the window WM illustrated in FIG. 4A. In FIG. 4B, an upper surface of the glass substrate GS may provide the display surface FS of FIGS. 2A to 2C.

In an embodiment of the inventive concept, the stacked structure of the window WM may be modified. In an embodiment of the inventive concept, the resin layer RL may be omitted. For example, in an embodiment of the inventive concept, the resin layer RL may be replaced with an adhesive layer such as, for example, a pressure-sensitive adhesive sheet. A protective film may be further disposed on the adhesive layer.

According to FIG. 4C, the glass substrate GS may include a plurality of parts which are distinguished according to a crystallization rate. Hereinafter, a glass substrate GS including a first part GS1, a second part GS2, and a third part GS3 will be described as an example. The second part GS2 and the third part GS3 may each have a higher crystallization rate than the first part GS1. When amorphous glass is heat-treated, a specific composition inside the glass grows into a crystal, and the glass changes into a crystalline substance. The crystallization rate of the glass is determined based on the degree of heat treatment.

In an embodiment of the inventive concept, the first part GS1 may include amorphous glass. However, embodiments of the present inventive concept are not limited thereto, and the first part GS1 may also include heat-treated glass such that the first part GS1 has a lower crystallization rate than each of the second part GS2 and the third part GS3.

The second part GS2 may be disposed at a first side of the first part GS1, and the third part GS3 may be disposed at a second side of the first part GS1. That is, the first part GS1 may be disposed between the second part GS2 and the third part GS3, the surface of the first side of the first part GS1 may be in contact with the second part GS2, and the surface of the second side of the first part GS1 may be in contact with the third part GS3. In some examples, the crystallization rates of the second part GS2 and the third part GS3 may each be 30% or more to increase mechanical strength. In some aspects, the crystallization rates of the second part GS2 and the third part GS3 may be 80% or less or be 50% or less to increase transparency. The crystallization rate may be measured by X-ray diffraction (XRD) and transmission electron microscopy (TEM).

The first part GS1 may correspond to (or overlap) the folding region FA-W. Embodiments of the inventive concept are not limited to the first part GS1 completely coinciding with the folding region FA-W. For example, a portion of the second part GS2 and a portion of the third part GS3 may overlap the folding region FA-W, and portions of the first part GS1 may respectively overlap the first non-folding NFA1-W and the second non-folding region NFA2-W.

The second part GS2 and the third part GS3 may include crystalline glass. The crystalline glass is obtained by crystallizing amorphous glass through heat treatment and corresponds to ceramic glass. The crystalline glass has a high elastic modulus and high impact strength compared to the amorphous glass.

The first part GS1 has a smaller thickness than the second part GS2 and the third part GS3. The wording, “the first part GS1 has a smaller thickness than the second part GS2 and the third part GS3”, may be the result of comparing measurement values at any of measurement points of the first part GS1, the second part GS2, and the third part GS3, may be the result of comparing average thicknesses, or may be the result of comparing the maximum thickness of the first part GS1 with each of a minimum thickness of the second part GS2 and a minimum thickness of the third part GS3. However, thicknesses measured at a boundary between the first part GS1 and the second part GS2 and a boundary between the first part GS1 and the third part GS3 may be excluded from the thickness comparison.

The first part GS1 may have a substantially uniform thickness. Each of the second part GS2 and the third part GS3 has a uniform thickness, but may have a region in which the thickness changes. The thickness of the first part GS1 may range from about 10 μm to about 50 μm, and the each of a thickness of the second part GS2 and a thickness of the third part GS3 may range from about 50 μm to about 100 μm. The thickness of the first part GS1 is measured at a first point P1 located on an upper surface US of the first part GS1, the thickness of the second part GS2 is measured at a second point P2 located on an upper surface US of the second part GS2, and the thickness of the third part GS3 is measured at a third point P3 located on an upper surface US of the third part GS3.

Each of the second point P2 and the third point P3 is spaced apart from the first point P1. Thicknesses of the first part GS1 and the second part GS2 measured at a boundary (or boundary point) between the first part GS1 and the second part GS2 may be equal to each other, and thicknesses of the first part GS1 and the third part GS3 measured at a boundary (or boundary point) between the first part GS1 and the third part GS3 may be equal to each other. The first point P1 and the second point P2 do not overlap the boundary between the first part GS1 and the second part GS2, and the first point P1 and the third point P3 do not overlap the boundary between the first part GS1 and the third part GS3.

Even when the thickness of the second part GS2 is measured at one point of an inclined surface IS of the second part GS2, and the thickness of the third part GS3 is measured at one point of an inclined surface IS of the third part GS3, the thickness of the first part GS1 is smaller than the each of a thickness of the second part GS2 and a thickness of the third part GS3.

Even when the first part GS1 has a non-uniform thickness, the thickness measured at the maximum thickness of the first part GS1 may be smaller than the thickness measured at an arbitrary point of the second part GS2 and the thickness measured at an arbitrary point of the third part GS3. However, the arbitrary points are not located at the boundary between the first part GS1 and the second part GS2 and the boundary between the first part GS1 and the third part GS3.

According to the structure described herein, the second part GS2 and the third part GS3, which occupy a larger area than the first part GS1, have a larger elastic modulus than the first part GS1, thereby improving the impact resistance of the window WM. Since the first part GS1 has a smaller elastic modulus than the elastic modulus of each of the second part GS2 and the third part GS3, the amount of stress occurring in the window WM during folding may be reduced.

The glass substrate GS includes a first surface S1 and a second surface S2 opposite to each other in a third direction DR3, and the resin layer RL includes a first surface S10 and a second surface S20 opposite to each other in the third direction DR3. In FIG. 4C, the first surface S1 of the glass substrate GS is illustrated as the upper surface of the glass substrate GS, and the first surface S10 of the resin layer RL is illustrated as the upper surface of the resin layer RL. The first surface S1 of the glass substrate GS and the second surface S20 of the resin layer RL are in contact with each other.

The glass substrate GS and the resin layer RL may have different thicknesses according to regions. A groove GV may be formed in the glass substrate GS. The groove GV may be defined by the upper surface US of the first part GS1, the inclined surface IS of the second part GS2, and the inclined surface IS of the third part GS3. The inclined surface IS of the second part GS2 and the inclined surface IS of the third part GS3 face each other, with the first part GS1 between the inclined surface IS of the second part GS2 and the inclined surface IS of the third part GS3. The inclined surface IS of the second part GS2 extends from the upper surface US of the second part GS2, and the inclined surface IS of the third part GS3 extends from the upper surface US of the third part GS3. The upper surface US of the first part GS1, the upper surface US of the second part GS2, the upper surface US of the third part GS3, the inclined surface IS of the second part GS2, and the inclined surface IS of the third part GS3 define the first surface S1 of the glass substrate GS.

The first part GS1 includes a lower surface opposite to the upper surface US of the first part GS1, the second part GS2 includes a lower surface opposite to the upper surface US of the second part GS2, and the third part GS3 includes a lower surface opposite to the upper surface US of the third part GS3. The lower surface of the first part GS1, the lower surface of the second part GS2, and the lower surface of the third part GS3 define the same flat surface. The flat surface is illustrated as the second surface S2 of FIG. 4C.

The resin layer RL may fill the groove GV and may provide a flat upper surface. The first part RL1 of the resin layer RL corresponding to the folding region FA-W may have a greater thickness than the second part RL2 and the third part RL3 of the resin layer RL which respectively correspond to the first and second non-folding regions NFA1-W and NFA2-W. Since the second surface S2 of the glass substrate GS provides a flat surface, and the first surface S10 of the resin layer RL provides a flat surface, the window WM may have a uniform thickness.

FIG. 4D is an enlarged cross-sectional view of the first part GS1. The first part GS1 may include a chemically strengthened glass. The first part GS1 may include a tensile stress region TP and compression stress regions SP1 and SP2. The first compression stress region SP1 and the second compression stress region SP2 are defined on both sides of the tensile stress region TP in the thickness direction. Since the same chemical strengthening is performed on the first surface S1 and the second surface S2, the first compression stress region SP1 and the second compression stress region SP2 may have the same thickness or the same depth.

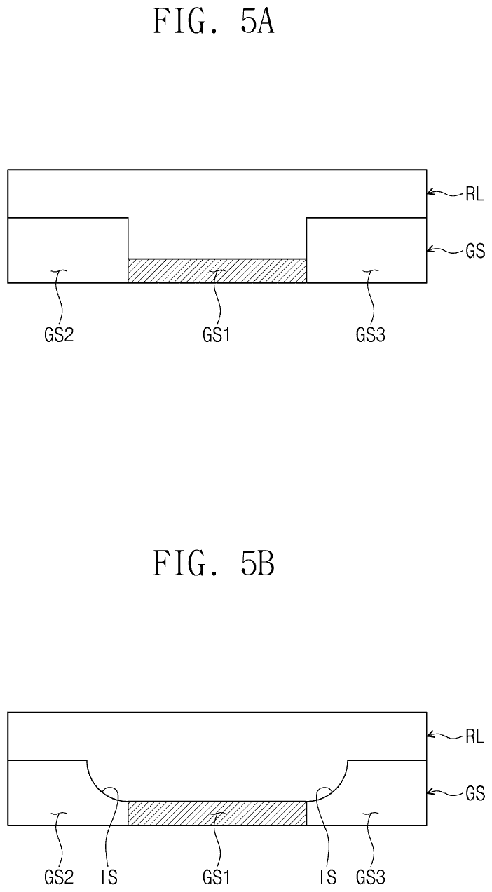

FIGS. 5A and 5B are cross-sectional views of the window WM according to an embodiment of the inventive concept. FIGS. 5A and 5B illustrate cross-sectional views corresponding to FIG. 4C. Hereinafter, a detailed description of the same component described with reference to FIG. 4C is referred back to by the explanation of FIG. 4C.

As illustrated in FIG. 5A, the second part GS2 and the third part GS3 may each have a substantially uniform thickness. The inclined surface IS illustrated in FIG. 4C may be omitted.

As illustrated in FIG. 5B, the inclined surface IS of each of the second part GS2 and the third part GS3 may be a curved surface. Although a concave inclined surface IS is illustrated as an example, the inclined surface IS may be a convex curved surface.

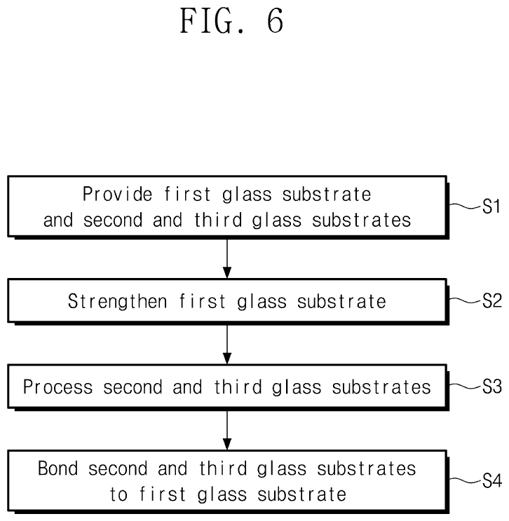

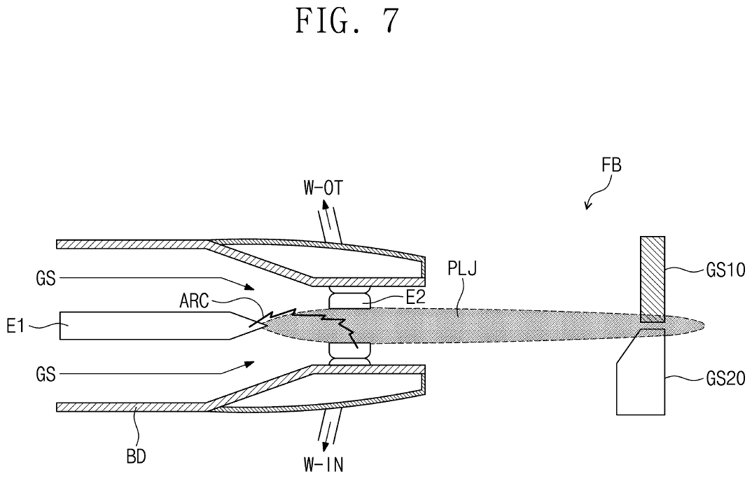

FIG. 6 is a flowchart illustrating a method of manufacturing a window WM according to an embodiment of the inventive concept. FIG. 7 is a diagram illustrating plasma bonding equipment FB according to an embodiment of the inventive concept.

In the descriptions of the method and processes herein, the operations may be performed in a different order than the order shown and/or described, or the operations may be performed in different orders or at different times. Certain operations may also be left out of the flowcharts, one or more operations may be repeated, or other operations may be added. Descriptions that an element “may be disposed,” “may be formed,” and the like include methods, processes, and techniques for disposing, forming, positioning, and modifying the element, and the like in accordance with example aspects described herein.

As illustrated in FIG. 6, the method may include providing a first, a first glass substrate, a second glass substrate, and a third glass substrate (S1). The first glass substrate, the second glass substrate, and the third glass substrate may include amorphous glass.

Next, the method may include chemically strengthening the first glass substrate (S2). Chemical strengthening may be performed with a salt containing the ionic salts (for example, a liquid ionic salt). A plurality of potassium ions (K+) are provided to the first glass substrate. Accordingly, the first glass substrate may include a medium, and sodium ions (Na+) and potassium ions (K+), which are dispersed in the medium. The potassium ions (K+) are absorbed from the ionic salt to the first glass substrate by substituting for the sodium ions (Na+) dispersed in the medium.

Depending on the degree of substitution of potassium ions (K+) and sodium ions (Na+), the intensity of surface stress (or surface compressive stress), the intensity of internal stress (or internal tensile stress), and the depth of compression stress regions (SP), that is, the depth of layer (DOL), may be determined. Compressive stress regions are respectively defined on both sides of the first glass substrate. These compressive stress regions correspond to the first compression stress region SP1 and the second compression stress region SP2 described with reference to FIG. 4D. In an embodiment of the inventive concept, the step of chemically strengthening the first glass substrate may be omitted.

Thereafter, the method may include processing the second and third glass substrates (S3). The second and third glass substrates may be heat-treated to convert amorphous glass into crystalline glass. In some aspects, portions of the second and third glass substrates may be removed by using CNC glass cutting equipment. In this way, the inclined surface IS illustrated in FIG. 4C may be formed. The order of processing the second glass substrate and the third glass substrate is not particularly limited, and the processing may be performed simultaneously or sequentially.

In an embodiment of the inventive concept, the step of removing portions of the second and third glass substrates may be omitted. For example, as in FIG. 5A, for a case in which the entire region of each of the second part GS2 and the third part GS3 has a substantially uniform thickness, the step of removing portions of the second and third glass substrates is not performed. In this embodiment, for example, the step of processing the second and third glass substrates may include a step of heat treating the second and third glass substrates to convert amorphous glass into crystalline glass.

Next, the method may include bonding the second and third glass substrates to the first glass substrate (S4). The plasma bonding equipment FB illustrated in FIG. 7 may be used. The plasma bonding equipment FB illustrated in FIG. 7 includes a cylindrical body part BD and a first electrode E1 and a second electrode E2 disposed in the body part BD. The first electrode E1 and the second electrode E2 may be electrodes having polarities opposite to each other, and the first electrode E1 may be a cathode, and the second electrode E2 may be an anode. The first electrode E1 may have a sharp end portion.

In an example in which a predetermined gas GS is provided into the body part BD and a voltage having a high potential difference is applied between the first electrode E1 and the second electrode E2, an arc discharge ARC is generated between the end portion of the first electrode E1 and the second electrode E2. The gas GS may contain oxygen. The gas GS may be ionized by the arc discharge ARC, thereby forming a form plasma jet PLJ (also referred to herein as a plasma stream or a stream of plasma). The plasma bonding equipment FB may include a cooling water inlet W-IN and a cooling water outlet W-OUT. In some aspects, the method may include providing a blocking gas (or a shielding gas) around the plasma jet PLJ such that the degree of concentration of the plasma jet PLJ is improved.

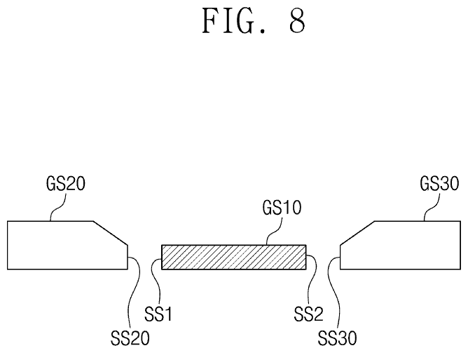

As illustrated in FIG. 8, a chemically strengthened first glass substrate GS10, a processed second glass substrate GS20, and a processed third glass substrate GS30 are provided. The plasma jet PLJ illustrated in FIG. 7 may be provided to the chemically strengthened first glass substrate GS10 and the processed second glass substrate GS20. Although not illustrated in FIG. 7, the plasma jet PLJ may also be provided to the processed third glass substrate GS30. A first side surface SS1 of the chemically strengthened first glass substrate GS10 and a side surface SS20 of the processed second glass substrate GS20 may be bonded. For example, the plasma jet PLJ provides an oxygen functional group. The oxygen functional group bonded to the first side surface SS1 of the first glass substrate GS10 covalently bonds with the silicon atom of the second glass substrate GS20, and the oxygen functional group bonded to the side surface SS20 of the second glass substrate GS20 covalently bonds with the silicon atom of the first glass substrate GS10. Accordingly, the first side surface SS1 of the first glass substrate GS10 and the side surface SS20 of the second glass substrate GS20 may be physically bonded.

In this way, the processed third glass substrate GS30 is further bonded to a second side surface SS2 of the first glass substrate GS10. In an example in which a side surface SS30 of the third glass substrate GS30 is physically bonded to the second side surface SS2 of the first glass substrate GS10, the glass substrate GS illustrated in FIG. 4C may be formed. Thereafter, when liquid resin is applied to the glass substrate GS and then dried, the resin layer RL illustrated in FIG. 4C may be formed.

According to the foregoing, the amount of stress occurring in the window during folding may be reduced. In some aspects, the impact resistance of the window may be increased.

In the above, description has been made with reference to embodiments of the inventive concept, but those skilled or of ordinary skill in the art may understand that various modifications and changes may be made to the inventive concept insofar as such modifications and changes do not depart from the spirit and technical scope of the inventive concept set forth in the claims to be described later.

Therefore, the technical scope of the inventive concept is not to be limited to the contents stated in the detailed description of the specification, but should be determined by the claims.

What is claimed is:

1. A window for a display device, the window comprising a glass substrate,
wherein the glass substrate comprises:
a first part;
a second part having a crystallization rate greater than a crystallization rate of the first part and positioned at a first side of the first part; and
a third part having a crystallization rate greater than the crystallization rate of the first part and positioned at a second side of the first part,
wherein a thickness of the first part is smaller than each of a thickness of the second part and a thickness of the third part.

2. The window of claim 1, wherein the first part comprises amorphous glass.

3. The window of claim 1, wherein the crystallization rate of the second part ranges from about 30% to about 80%.

4. The window of claim 1, wherein:
the second part comprises an upper surface and an inclined surface extending from the upper surface of the second part,
the third part comprises an upper surface and an inclined surface extending from the upper surface of the third part, and
the inclined surface of the second part and the inclined surface of the third part are opposite to each other with an upper surface of the first part between the inclined surface of the second part and the inclined surface of the third part.

5. The window of claim 4, wherein:
the first part further comprises a lower surface opposite to the upper surface of the first part,
the second part further comprises a lower surface opposite to the upper surface of the second part,
the third part further comprises a lower surface opposite to the upper surface of the third part, and
the lower surface of the first part, the lower surface of the second part, and the lower surface of the third part define a flat surface.

6. The window of claim 1, wherein an elastic modulus of the first part is smaller than an elastic modulus of the second part.

7. The window of claim 1, wherein:
the thickness of the first part ranges from about 10 μm to about 100 μm, and
the thickness of the second part ranges from about 50 μm to about 100 μm.

8. A method of manufacturing a window for a display device, comprising:
providing a first glass substrate comprising amorphous glass, a second glass substrate comprising crystalline glass, and a third glass substrate comprising the crystalline glass;
bonding a first side surface of the first glass substrate and a side surface of the second glass substrate; and
bonding a side surface of the third glass substrate and a second side surface of the first glass substrate opposite to the first side surface of the first glass substrate,
wherein a thickness of the first glass substrate is smaller than each of a thickness of the second glass substrate and a thickness of the third glass substrate.

9. The method of claim 8, wherein the bonding of the first side surface of the first glass substrate and the side surface of the second glass substrate comprises providing a plasma stream to the first side surface of the first glass substrate and the side surface of the second glass substrate.

10. A display device comprising:
a display panel comprising a folding region, a first non-folding region, and a second non-folding region, wherein the first non-folding region and the second non-folding region are opposite to each other with the folding region between the first non-folding region and the second non-folding region; and
a window comprising a glass substrate and coupled to the display panel,
wherein the glass substrate comprises,
a first part overlapping the folding region,
a second part overlapping the first non-folding region, having a crystallization rate greater than a crystallization rate of the first part, and positioned at a first side of the first part, and
a third part overlapping the second non-folding region, having a crystallization rate greater than the crystallization rate of the first part, and positioned at a second side of the first part,
wherein:
the second part and the third part are opposite to each other with the first part between the second part and the third part, and
a thickness of the first part is smaller than each of a thickness of the second part and a thickness of the third part.

11. The display device of claim 10, wherein:
the second part comprises an upper surface and an inclined surface extending from the upper surface of the second part,
the third part comprises an upper surface and an inclined surface extending from the upper surface of the third part, and
the inclined surface of the second part and the inclined surface of the third part are opposite to each other with the first part between the inclined surface of the second part and the inclined surface of the third part.

12. The display device of claim 10, wherein an elastic modulus of the first part is smaller than an elastic modulus of the second part.

13. The display device of claim 10, wherein the thickness of the first part ranges from about 10 μm to about 50 μm, and the thickness of the second part ranges from about 50 μm to about 100 μm.

14. An electronic device comprising:
a display device comprising a folding region, a first non-folding region, and a second non-folding region, wherein the first non-folding region and the second non-folding region are opposite to each other with the folding region between the first non-folding region and the second non-folding region; and
a housing accommodating the display device,
wherein:
the display device further comprises a display panel and a window coupled to the display panel,
the window comprises a glass substrate, and
the glass substrate comprises:
a first part overlapping the folding region,
a second part overlapping the first non-folding region, having a crystallization rate greater than a crystallization rate of the first part, and positioned at a first side of the first part, and
a third part overlapping the second non-folding region, having a crystallization rate greater than a crystallization rate of the first part, and positioned at a second side of the first part,
wherein:
the second part and the third part are opposite to each other with the first part between the second part and the third part, and
a thickness of the first part is smaller than each of a thickness of the second part and a thickness of the third part.

15. The electronic device of claim 14, wherein the electronic device is any one among a mobile phone, a smart watch, or an information providing device for a vehicle.

16. The electronic device of claim 14, wherein:
the second part comprises an upper surface and an inclined surface extending from the upper surface of the second part,
the third part comprises an upper surface and an inclined surface extending from the upper surface of the third part, and
the inclined surface of the second part and the inclined surface of the third part are opposite to each other with an upper surface of the first part between the inclined surface of the second part and the inclined surface of the third part.

17. The electronic device of claim 14, wherein an elastic modulus of the first part is smaller than an elastic modulus of the second part.

18. The electronic device of claim 14, wherein:
the thickness of the first part ranges from about 10 μm to about 50 μm, and the thickness of the second part ranges from about 50 μm to about 100 μm.

19. The electronic device of claim 14, wherein the first part comprises amorphous glass.

20. The electronic device of claim 14, wherein the crystallization rate of the second part ranges from about 30% to about 80%.
